(19) United States
(12) Patent Application Publication
(10) Pub. No.: US 2013/0091679 A1
(43) Pub. Date: Apr. 18, 2013

(54) Device And Method For Assembling Sets Of Instruments

(71) Applicants: Oliver Gloger, Berlin (DE); Omid Abri, Berlin (DE)

(72) Inventors: Oliver Gloger, Berlin (DE); Omid Abri, Berlin (DE)

(21) Appl. No.: 13/650,719

(22) Filed: Oct. 12, 2012

(30) Foreign Application Priority Data
Oct. 13, 2011 (DE) 10 2011 054 452.6

(51) Int. Cl. B23P 21/00; B23P 11/00

(52) U.S. Cl. 29/407.04; 29/720

(57) ABSTRACT

The invention relates to a device for assembling sets of instruments, having a data processing installation and a fine identification unit. The data processing installation has a display unit, a database, a first interface and an evaluation unit. The fine identification unit has a first support for placing the instruments of a set of instruments thereon and a first camera. The first camera is arranged and oriented such that it can capture image data from instruments to be identified and arranged on the first support from at least one perspective, and the data processing installation is designed such that it uses the first interface to receive image data from the first camera and can store the received image data in the database. It can further visually identify a respective instrument by use of the evaluation unit. The invention also relates to an according method for assembling sets of instruments.

### BACKGROUND OF THE INVENTION

The present invention relates to a device and a method for assembling sets of medical instruments.

In medicine, specifically in the case of medical operations, various medical instruments are required for medical interventions depending on the type and scope of the intervention. These medical instruments are combined on the basis of the respective intervention to form a complete set of instruments. This set of instruments contains all the medical instruments—simply often referred to as instruments below—that are necessary for the planned intervention.

In order to avoid infections during these medical interventions, the required medical instruments need to be cleaned and sterilized prior to the intervention. This is accomplished by cleaning and sterilizing a set of instruments that has already been assembled. To this end, this set of instruments is preferably placed onto what is known as an instrument tray. This instrument tray with the medical instruments is suitable for being transferred to and subsequently removed again from washing machines or sterilization apparatuses. This instrument tray then contains all the necessary instruments laid out ready for the respective imminent intervention. In this context, such an instrument tray with the set of instruments may vary not only from one type of intervention to another but also from hospital to hospital or even from one department in a hospital to another. In addition to the assembly of the respective set of instruments in an instrument tray, the precise arrangement of the instruments in the respective instrument tray, i.e. the manner of packing, is also important and requires attention to be paid in this context. Ultimately, this results in an individual instrument tray setup that needs to be considered for each individual department.

In practice, this is accomplished by virtue of there being a specific packing list for each instrument tray. This packing list contains not only the information about which instruments belong to the respective set of instruments but also information concerning the manner in which the instruments are packed in the instrument tray. Using this packing list, the instrument tray is then stocked or packed by a packer in a sterilization department. This involves the cleaned instruments normally first of all being checked for operational status and then being placed into the instrument trays in accordance with the packing list. They are then sterilized in special containers.

In order to make processes of this type effective in hospitals, these sets of instruments are each prepared in this manner for the day or even several days in advance, at least for standard interventions and for planned interventions. This means that these instrument trays are then already available in sterile form and now only need be taken from a storage location for the respective imminent interventions and operations. In order to additionally optimize the effectiveness and the cost saving, this today is handled, particularly in smaller hospitals, such that the cleaning and sterilization processes are ceded to external companies.

So as not to lose the advantage of these optimizations by virtue of additionally required instruments needing to be procured subsequently because an instrument tray was incompletely packed, it is necessary for the instrument trays to be packed, prepared and sterilized carefully and with all the necessary medical instruments, i.e. completely. A missing instrument is serious, particularly during an operation, because such instruments need to be subsequently sterilized or taken from other sources and channelled into the operating area.

This means that, both in sterilization departments in hospitals and in external companies, the particular people commissioned to assemble the sets of instruments must always work carefully and attentively when stocking the instrument trays in order to avoid packing faults.

In order to retain a better overview and inspection for these processes, DE 196 14 719 A1, for example, proposes providing the relevant instruments with identifiers which can be read by a data processing installation. These identifiers may be barcodes or matrix codes, for example, or else may be in the form of normally readable characters. A user can then use a suitable reader to read these barcodes and matrix codes or labels into the computer, which then in turn identifies which instrument is involved. By way of example, it is therefore possible to store a packing list for a set of instruments in the data processing installation. This packing list is then worked through by a user and the instruments of the set are assembled, after which the identifiers of the instruments are subsequently read into the data processing installation. The latter then compares the instruments identified in this manner by the identifiers with the specifications of the packing list. If an instrument is missing or if an instrument has been packed incorrectly by the user, the data processing installation then points out this fault to the user.

Despite the advantages that can be identified, this proposed option has various disadvantages. Firstly, each instrument needs to be read in individually, which represents a very great time involvement and also does not allow the manner of packing to be checked. Added to this are also possible faults when the identifiers of the medical instruments are read in, necessitating repetition of the read-in process. Particularly when there is a large number of medical instruments, the use of matrix codes will admittedly be suitable, since they provide greater capacity on a particular surface area in comparison with barcodes, for example. By contrast, however, matrix codes have the disadvantage that they are more frequently subject to read errors than other comparable codings.

This is additionally complicated by the fact that any identifier on such medical instruments becomes defective or fades over time, since the medical instruments normally undergo numerous sterilization passes during their life. The cleaning with aggressive cleaning and sterilization agents means that the relevant marks become increasingly faint and therefore ultimately no longer legible over time.

Furthermore, in the case of more complex instruments which are disassembled and subsequently reassembled again for the sterilization process, it may be difficult to put an appropriate identifier onto all individual parts. This is the case particularly with very small instruments and instrument parts.

Besides the reading problems, marking the instruments is also time-consuming and costly per se. This usually requires the instrument to be engraved. This in turn requires for the most part separate technical tools.

US 2011/0005342 A1 describes systems and methods for processing a plurality of surgical instruments for cleaning and/or packaging. Therein, the surgical instruments are identified and oriented according to type and using an automated apparatus. Further, specialized tools are provided for automatically opening and closing surgical instruments, flipping instruments and assisting in the processing and maintenance of surgical instruments. Identifying the surgical instruments is realised via machine vision. This results in identifying the instruments based on image comparison. The further process of handling the surgical instruments relies on the correct handling by the system or a user. If such errors in the packing occur, they are not detected by the system during the packing or before the provision of a container of instruments.

U.S. Pat. No. 4,943,939 describes an apparatus for accounting for surgical instruments dispensed into and withdrawn from the surgical operating environment. For this, a modified mayo-stand is suggested having means for recording image data of instruments placed thereon. These image data are used for monitoring the instruments in the operating environment. This is done via some key features in order to recognise the instruments in use. A specific identification of instruments as used and needed for assembling instrument sets is not possible with such a basic recognition, which also does not provide a final control of a set of instruments to be sterilised, e.g. in an instrument tray.

### SUMMARY OF THE INVENTION

The present invention is based on the object of providing a device and a method which firstly optimizes the packing process for the aforementioned sets of instruments and makes it especially reliable but secondly keeps down the time and cost involvement for identifying the medical instruments and reduces the vulnerability and problems in connection with the permanence of the markings and with the possibility of marking the instruments per se.

This object is achieved in a first aspect according to the present invention by a device for assembling sets of medical instruments, with:
a data processing installation,
a fine identification unit, and
a coarse identification unit
the data processing installation having:
   a display unit,
   a database,
   a first interface, and
   an evaluation unit; and
the fine identification unit having:
   a first support, for placing the medical instruments of a set of instruments thereon, and
   a first camera; and
the coarse identification unit having:
   a support;

wherein the first camera is arranged and oriented such that it can capture image data of medical instruments to be identified and arranged on the first support from at least one perspective,

wherein the data processing installation is designed such that
it uses the first interface to receive image data from the first camera,
it can store the received image data in the database,
it can use the evaluation unit to compare the received image data with already stored image data from medical instruments, and
it can thereby visually identify a respective medical instrument, and

wherein on the support of said coarse identification unit the instruments can be combined to form a set of instruments following the visual identification in the fine identification unit,

wherein the support of the coarse identification unit is preferably formed by a second support. Alternatively, the support of the coarse identification unit may also be formed by the first support of the fine identification unit. In this case, the fine and coarse identification units would then coincide in terms of design.

This embodiment has the overall advantage that the identified set of instruments is now once again placed onto a support prior to sterilization, so that a final completeness check can take place on said support for confirmation purposes before the set of instruments is finally transferred to sterilization. To this end, the instruments are usually assembled in an instrument tray to form a set of instruments.

In the previously mentioned DE 196 14 719 A1 it may occur, in contrast to the device according to the present invention, that when identifiers are individually identified on the medical instruments, the relevant user does not transfer the instrument to sterilization or cleaning even after successful identification of each medical instrument. Hence, although the instrument has been identified as being present, it is actually not situated in the instrument tray.

This is prevented in this case by the assembly of all of the instruments identified by the fine identification unit and the performance of a completeness check for this assembled set of instruments by the coarse identification unit. The complete set is supplied to further cleaning and sterilization only if the set is complete.

The advantage with regard to US 2011/0005342 A1 and U.S. Pat. No. 4,943,939 is that one or more identification or packing errors may be detected by the second (coarse) check of the set of instruments by the device, i.e. via the coarse identification unit, prior to use, that is to say before the sterilization or before the provision of the ready to use set of instruments at the latest. The increases the reliability of the device according to the present invention significantly.

Further, the device according to the present invention has, especially with respect to systems that require identifiers on the instruments, the advantage that it is possible to identify the instruments by capturing the image data with a camera in conjunction with the appropriately configured data processing installation without the need for identifiers on the instruments. Besides identifying the instruments, it is then simultaneously possible to check the arrangement of said instruments on the support, that is to say the manner of packing.

This will usually involve a prior learning phase for the relevant instruments, in which the respective instruments are captured and identified by the camera and the data processing installation and have an appropriate identifier associated with them in the process. In addition, said identifier is stored in the database of the data processing installation together with the reference image data. This may also take account of the fact that individual instruments have a different image representation, depending on how they are placed onto the support. As an example, mention may be made here of curved scissors or clamps, the image representations of which, as captured by the camera, are different depending on the side on which they are placed. This is evident from the fact that the representations cannot be made congruent with one another by rotation or translation. For this reason, the relevant possible laying positions can then be learned separately and stored under the same identifier in the database.

In addition, the device has the advantage that not every instrument needs to be identified or read in individually, but rather the total number of all the instruments in a set of instruments can be spread out on the (first) support. The device can then capture an overall image of the support with the relevant instruments by means of the camera and forward the captured image data to the data processing installation. The evaluation unit of the data processing installation can then use appropriate object identification algorithms to identify the individual instruments and can then compare the latter with the packing list for the set of instruments that is to be packed. Examples of such algorithms and methods of object identification are correlation methods in which correlation is used to determine where on the image an object that has been learned by training is located. In this regard, the reference images of the object that have been learned by training are moved iteratively over the captured overall image and, for each position, it is determined what correlation value a respective reference image has at the relevant position in the overall image. The maximum correlation over all the different reference images then indicates which object is located at which position in the overall image and hence on the support. In this case, the correlation can be ascertained by using the respective image channel values, for example. Alternatively, an edge-based comparison method, in which instead of the image channel values the edges of the objects are thus used as comparison values, is also conceivable.

As an alternative method of identification, generalized Hough transformation may also be mentioned here by way of example. This first of all involves various search objects being learned by training using their edge information, and the direction vectors between the focal point of the object and the edge pixels being stored for each reference object. The identification is then made by using the edge pixels and the shifts in position stored therefore relative to the focal point of the object. As an alternative to this, the method of object categorization involves subregions of the objects being learned by training and the respective direction vectors to the focal point of the object being stored. The identification is then accordingly made by identifying subregions in the overall image and the position of said subregions relative to the focal point of the object.

For the purpose of speeding up the object identification, it is also conceivable to limit the identification to finding key features. Within the context of this invention, the term “key features” is intended to be understood to mean visual instrument features. These can be predetermined automatically when an instrument is learned by training or else can be calculated for each instrument by means of automatic algorithms. They usually involve conspicuous, prominent and/or highly visible areas of the respective instrument. For this reason, it is also possible for particularly an experienced packer or user himself to specify, during training, which instrument areas are key features which distinguish them from other instruments of very similar design. These may also be small details, such as small instrument parts, various surface corrugations, indentations, small grooves or the like. Markers or other identifications that have been put on specifically for this purpose are also conceivable. By way of example, key features are alternatively or additionally automatically determined by means of what are known as interest operators, such as the Förstner operator or the Moravec operator.

In order to allow exact identification of the individual instruments, said instruments should be arranged next to one another on the first support, preferably without overlapping. It is possible to depart from this in the case of identification using key features, however.

According to an embodiment of the device according to the present invention, the first support has a contrast-enhancing background being arranged such that it is located behind an instrument to be identified, from the respective camera perspective.

The use of a contrast-enhancing background has the advantage that association of the image data with respective instrument types is simplified in the case of the object identification methods mentioned previously by way of example. The reason for this is that the distinction between the supposed instrument and the background becomes clearer and hence more explicit for a relevant object identification algorithm. This is important particularly in the case of the present medical instruments, since they are usually made from medical steel, which, with its shiny grey surface, stands out from regular, that is to say white, bases only with difficulty. In addition, such an explicitly different background also allows the image information in the background to be reliably filtered out. Such a contrast-enhancing background may be a blue area, for example.

According to another embodiment of the device according to the present invention, the first camera first camera is arranged such that the position thereof can be altered such that it can capture image data from at least two perspectives.

The term “perspective” as used within the context of the present invention is to be understood as meaning the orientation of a respective camera in relation to a respective instrument in terms of angle of azimuth and polar angle. In this context, a change in the perspective results in a change in this orientation by virtue of at least one of these two angles, which, together with the distance to the origin of a spherical coordinate system, explicitly determine the position of an object in such a system, being altered.

This arrangement advantageously allows the camera to capture image data from an arrangement of instruments on the support from a plurality of orientations. This allows an increase in the explicitness and reliability of the identification of the medical instruments, since additional snapshots from other perspectives increase the number of information items. This is particularly useful in the case of more complex medical instruments, which frequently differ in terms of small details which it might not be possible to identify from just a single orientation.

According to another embodiment of the device according to the present invention, the first support has a transparent base area onto which the instruments to be identified can be placed.

This embodiment has the advantage that the capture of the image data is not limited to one side of the support. Thus, this embodiment also allows image data to be captured from underneath the support. Preferably glass or transparent plastics, such as Plexiglas, are suitable for the configuration of the transparent base area.

According to another embodiment of the device according to the present invention, the fine identification further comprises a second camera being arranged and oriented such that it can capture image data from instruments to be identified and arranged on the first support from at least one further perspective,

wherein the data processing installation is further designed such that
it uses an interface to additionally receive image data from the second camera,
it can store the received image data from the second camera in the database,
it can use the evaluation unit to compare the received image data of the second camera with already stored image data from instruments, and
it can thereby visually identify a respective instrument; and

wherein the first camera is arranged on one side of the transparent base area and the second camera is arranged on the other, opposite side of the transparent base area,

wherein the second camera is preferably arranged such that the position thereof can be altered such that it can capture image data from at least two perspectives.

The provision of a second camera has the advantage that the previously described option of identifying and capturing the image data from the underside is possible without relatively great involvement in terms of adjusting the first camera. This merely requires the contrast-enhancing background to be displaced, depending on which camera is capturing image data, or to be present on both sides, as described previously. The interface which the data processing installation uses to receive the image data from the second camera may be either an additional interface in a manner similar to the statements made before or the aforementioned first interface.

The image data captured in this manner from the top and the underside of the medical instruments can be analyzed and evaluated together in the evaluation unit of the data processing installation, which significantly increases the hit ratio for the object identification of the instruments. In this context, it is preferably the case that, when an instrument is successfully identified using the image data from one side, it is possible to dispense with the evaluation or even the capture of the image data from the other side.

According to another embodiment of the device according to the present invention, the contrast-enhancing background can be displaced between a plurality of positions, wherein the plurality of positions are each situated on opposite sides of the transparent base area.

This embodiment has the advantage that the instruments are visually accessible from all sides. Thus, this preferred embodiment allows image data to be captured from the top and then, by rearranging the contrast-enhancing background, allows them to be captured from the underside. In this case, the respective arrangement of the contrast-enhancing background permits the instruments to be easily identified in the object identification unit in any camera perspective, as described before.

The contrast-enhancing background can be displaced preferably in a motor-driven fashion and automatically.

According to another embodiment of the device according to the present invention, the device comprises at least two contrast-enhancing backgrounds respectively arranged on opposite sides of the transparent base area such that at least one contrast-enhancing background is arranged behind a medical instrument arranged on the first support with respect to a respective perspective of the at least one camera.

In this embodiment a respective contrast-enhancing background is provided on each side of the transparent base area. Accordingly, this embodiment has the same advantages as the previously mentioned embodiment, i.e. that a medical instrument which is arranged on the transparent base area can have the image data captured from above as well as from below. Therefore, at least one contrast-enhancing background is always arranged on the back of the medical instrument to be detected, with respect to the camera perspective. In contrast to the previous embodiment, no rearrangement of the contrast-enhancing background is necessary. This embodiment is especially beneficial in embodiments where two cameras are used for the fine identification unit which are arranged on opposite sides of the transparent base area. This allows a simultaneous capturing of the image data by both cameras and, therefore, saves a lot of time.

According to another embodiment of the device according to the present invention, the support of the coarse identification unit has a scale, and

the data processing installation has a second interface and is further configured such that
it uses the second interface to receive weight data from the scale for the instrument set that has been placed onto the scale,
it can store the received weight data in the database, and
it can use the evaluation unit to compare the received weight data with already stored weight data from the visually identified instruments.

This embodiment has the advantage that there is thus now also an additional check on the complete set of instruments using a different identification method. In this case, the use of a scale has the advantage that, in contrast to individual identification of the medical instruments, the manner in which the medical instruments are placed onto the support is insignificant, since it does not influence the weight. Thus, it is possible for the medical instruments to overlap without this adversely affecting this manner of identification. This saves time and also space.

In addition, the use of a scale has the advantage that more complex instruments which comprise a plurality of assembled parts can therefore once again be checked for completeness. This may not be possible in the case of visual identification of the external characteristics, for example if a single part from the interior of the instrument is missing. If this is the case, the effect during determination of the weight, even of the total weight of the set of instruments, would be that the total weight of the set of instruments differs from the nominal weight.

The nominal weight of the set of instruments can be calculated individually in this case, preferably by the data processing installation. To this end, the data processing installation can call upon the weight information from the individual instruments which are part of the set of instruments that is to be packed. Alternatively, the total weight of a respective set of instruments may also be stored in connection with the packing list in the database of the data processing installation.

The stored reference weights of the respective instruments or else of the whole set of instruments can either be transferred to the database of the data processing installation according to manufacturers' specifications or can be captured in a separate training phase. In this case, it is conceivable for a plurality of weighing processes to be able to take place for an instrument or a respective complete set of instruments, said weighing processes being used to form an average and likewise being able to be used to store an appropriate deviation as well. This would then make it possible for a certain tolerance range to be stored in the database for the relevant weights of the instruments or sets of instruments on the basis of ascertained standard deviations. Thereby, a fault in packing is not reported in the case of just a minimum of weight difference, but rather the data processing installation reports an error for the assembled set of instruments only when the tolerance range has been exceeded.

According to another embodiment of the device according to the present invention, said coarse identification unit has a camera being arranged and oriented such that it can capture image data from a set of instruments on the support of said coarse identification unit from at least one perspective, and

wherein the data processing installation is further configured such that
it uses an interface to receive image data from the camera of the coarse identification unit,
it can store the received image data in the database,
it can use the evaluation unit to compare the received image data with already stored image data from instruments, and
it can thereby visually identify the respective instruments and can check the completeness of the set of instruments on the support of the coarse identification unit,

wherein the camera of the coarse identification unit is preferably formed by a further camera, and

wherein the data processing installation has preferably a third interface and is further configured such that it uses the third interface to receive the image data from the further camera.

This embodiment has the overall advantage that in this context the coarse identification of the set of instruments likewise again involves the use of a fast visual method which can likewise identify the individual instruments in the set of instruments.

Since instruments may also overlap in such a set of instruments on the support of the coarse identification unit, object identification using key features is preferably performed in this context. Hence, not all instruments need to be completely identifiable. In this case, it is possible to predetermine how many of the stored key features need to be identified. In addition, the identification of key features when identifying individual instruments is also particularly advantageous when instrument trays in which the instruments are assembled to form the respective sets of instruments. The reason for this is that the instrument trays, and the instruments themselves, are made of metal. Visual identification is therefore complicated generally by the fact that the background, that is to say the instrument tray, and the object to be identified, that is to say the instrument, are made from the same material and are therefore visually similar. In this case, concentrating on key features can achieve the necessary distinguishability.

Besides the possibility of using this second visual method on its own, in the same manner as the use of the previously described weighing method on its own, it is also possible to combine the two methods with one another in one preferred embodiment.

Such a device would then firstly have the previously described scale for determining the total weight of the set of instruments and also a (further) camera for identifying the instruments which have been placed onto the support using key features.

This combines the advantages of the individual identification of the instruments using the (further) camera with the possibility of also noticing missing internal parts of the instruments on account of the weight discrepancy.

Further, the advantages described previously in connection with the refinement having the scale, particularly that such a device can also perform a final check on the completeness of the set of instruments prior to sterilization and cleaning, are also obtained for the device having the camera, on its own or in combination with the scale.

In this context, besides this preferred embodiment of the further camera, it is likewise possible for the camera of the coarse identification unit to be identical to a camera of the fine identification unit.

According to another embodiment of the device according to the present invention, the camera of the coarse identification unit is arranged such that the position of the camera of the coarse identification unit can be altered such that it can capture image data from at least two perspectives.

As has also already been described previously, this has the advantage that this increases the reliability of the object identification method by virtue of more image information or image data being available. This is advantageous particularly when, as in this case of the coarse identification of instruments in an instrument tray, for example, there may be an overlap between instruments, and the device therefore also allows image information to be received from instruments which are overlapped either fully or in part by other instruments from one perspective.

According to another embodiment of the device according to the present invention, the support of the coarse identification unit has an instrument tray into which the instruments can be placed and in which the instruments can subsequently be sterilized as a complete set of instruments.

This embodiment of the device has the advantage that in this way it is now only necessary to take an already packed instrument tray from the support of the coarse identification unit. Accordingly, there is no need for any further single transfers of instruments from the support to sterilization or cleaning as individual instruments. In this way, the completeness of the set of instruments is therefore determined in the manner in which it actually lands in the instrument tray, which can be transferred directly to cleaning and sterilization apparatuses.

The object according to the present invention is further achieved by another aspect of the present invention by a method for assembling sets of medical instruments using a device for assembling sets of medical instruments, with:
a data processing installation,
a fine identification unit, and
a coarse identification unit
the data processing installation having:
   a display unit,
   a database,
   a first interface, and
   an evaluation unit; and
the fine identification unit having:
   a first support, for placing the medical instruments of a set of instruments thereon, and
   a first camera; and
the coarse identification unit having:
   a support;

wherein the first camera is arranged and oriented such that it can capture image data of medical instruments to be identified and arranged on the first support from at least one perspective,

wherein the data processing installation is designed such that
it uses the first interface to receive image data from the first camera,
it can store the received image data in the database,
it can use the evaluation unit to compare the received image data with already stored image data from medical instruments, and
it can thereby visually identify a respective medical instrument, and

wherein on the support of the coarse identification unit the instruments can be combined to form a set of instruments following the visual identification in the fine identification unit;

the method comprising the following steps:
a) placing at least one instrument onto the first support of the fine identification unit,
b) capturing image data by at least the first camera,
c) forwarding the image data to the data processing installation,
d) comparing the image data with the reference images stored in the database for the instruments in the set of instruments that is to be assembled, and
e) informing the user about missing or superfluous instruments or about the completeness of the set of instruments by means of the display unit.

This method has the advantage that the user does not need to have each instrument identified individually, but rather places a group of instruments onto the first support. This group may already form the set of instruments. When the captured image data have been compared with the reference images stored in the database, the latter being able to be received as a result of a previously described training phase, the user is thus easily provided, after a short time, with information regarding which instruments are missing, which are superfluous or incorrect and whether the set of instruments is thus complete and can be sterilized in the form in which it has been placed onto the support.

Further, the relevant advantages cited previously in connection with the device are also obtained for the described method of the present invention.

According to an embodiment of the method according to the present invention, in step b) the image data are captured by the first camera and a second camera.

This has the advantage that image data are thus available from at least two sides, as a result of which the object identification method becomes more reliable and, on account of the distinctly greater volume of information, also provides a reliable result more quickly.

According to another embodiment of the method according to the present invention, at least one camera captures image data from at least two perspectives by altering the respective position of the at least one camera.

This embodiment of the method also has the advantage that the volume of information is increased. Hence, there are again more image data available from the same arrangement of instruments, which increases the reliability of the object identification and speeds up successful object identification.

In this case, the position of the camera is preferably altered automatically. This can be accomplished by means of actuation by the data processing installation, for example.

According to another embodiment of the method according to the present invention, the method further comprises the following steps:
f) ascertaining the weight of the set of instruments with the scale,
g) forwarding the weight data from the scale to the data processing installation,
h) comparing the weight data with a nominal weight of the set of instruments, and
i) informing the user about the fault or the completeness of the set of instruments.

These method steps have the advantage that they once again allow a final check on the completeness of the instrument set prior to sterilization on the basis of the previously described individual identification of the instruments and on the correctness of these instruments in terms of the set of instruments that is to be assembled.

To this end, as described, use is made of coarse identification in this case, this being implemented by a scale in this specific embodiment according to the present invention. This has the advantage that the coarse identification can be performed very quickly. In addition, it is thus once again also possible to perform a final check on completeness for instruments that are to be assembled themselves. This is not always evident from the external appearance of the instrument. Further, reference is also made in this regard to the advantages already presented previously for the (use of a) scale.

According to another embodiment of the method according to the present invention, said method also has the following steps:
f) capturing image data of the set of instruments using the camera of the coarse identification unit,
g) forwarding the image data to the data processing installation,
h) comparing the image data with image data stored in the database for the instruments which are part of the set of instruments, and
I) informing the user about the fault or the completeness of the set of instruments,

wherein the comparison in step h) is preferably made using key features of the instruments.

In the case of this alternative for the coarse identification according to the present invention, a visual method is again used. This has the advantage that each instrument is again identified individually. It is therefore possible to determine an instrument that is missing precisely. So as to increase the speed in this case and to take as well account of the problem of overlapping instruments on the support of the coarse identification unit, the captured image data are searched for key features instead of identifying a complete instrument, as is the case with the fine identification described before.

According to another embodiment of the method according to the present invention, the method comprises the following steps between steps h) and I):
i) ascertaining the weight of the set of instruments using the scale,
j) forwarding the weight to the data processing installation, and
k) comparing the weight data with a nominal weight for the set of instruments.

This preferred embodiment has the advantage that the two coarse identification methods, i.e. the weighing method and the visual identification method using key features, can be combined with one another. This increases the reliability of this coarse identification. Since both methods can run parallel to one another, however, this does not increase the duration of this coarse identification method. Further, the aforementioned advantages of the individual methods of coarse identification complement one another.

It goes without saying that the features cited above and the features which are yet to be explained below can be used not only in the respectively indicated combination but also in other combinations or on their own without departing from the scope of the present invention.

### BRIEF DESCRIPTION OF THE DRAWINGS

The invention is described and explained in more detail below using a few selected exemplary embodiments in connection with the appended drawings, in which:

FIG. 1 shows a schematic perspective representation of a device according to the present invention with a fine identification unit,

FIG. 2 shows a schematic representation of the design of a data processing installation according to the present invention,

FIG. 3 shows a schematic perspective representation of a further device according to the present invention with a combination of fine identification unit and coarse identification unit, the latter having a camera,

FIG. 4 shows a schematic perspective representation of a further device according to the present invention with a combination of fine identification unit with coarse identification unit, the latter having a scale,

FIG. 5 shows a schematic representation of a data processing installation for a device as shown in FIG. 4,

FIG. 6 shows a schematic perspective representation of a coarse identification unit with a camera and a scale,

FIG. 7 shows a schematic representation of a data processing installation for an overall device with a coarse identification unit as shown in FIG. 6,

FIG. 8 shows a schematic perspective representation of a camera arrangement for fine and coarse identification units with an alterable perspective,

FIG. 9 shows a schematic side view of a device according to the present invention with a fine identification unit having a first and a second camera and an contrast-enhancing background below the instrument that is to be identified,

FIG. 10 shows a schematic side view of a device according to the present invention with a fine identification unit having a first and a second camera as shown in FIG. 9, with a contrast-enhancing background above the instrument that is to be identified,

FIG. 11 shows a schematic side view of a further device according to the present invention with a fine identification unit analogue to the device of FIGS. 9 and 10, having two contrast-enhancing backgrounds, and

FIG. 12 shows a schematic side view of a further device according to the present invention with a fine identification unit analogue to the devices of FIGS. 9, 10 and 11, having two contrast-enhancing backgrounds as well.

### DESCRIPTION OF PREFERRED EMBODIMENTS

The devices according to the present invention that are shown and described below are denoted by the reference numerals 10, 100, 150, 300, 350 and 370.

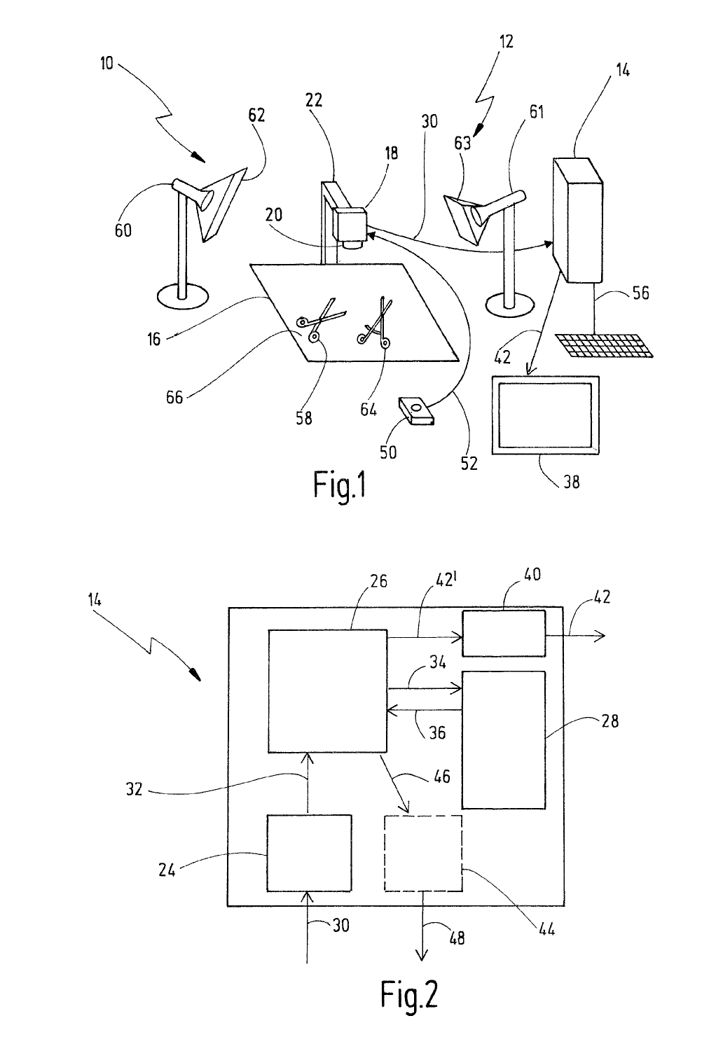

The device 10 according to the invention which is shown in FIG. 1 has a fine identification unit 12 and a data processing installation 14. The fine identification unit 12 has a first support 16 and a first camera 18.

The first camera 18 is arranged above the first support 16 such that the lens 20 thereof, and hence accordingly the perspective thereof, is directed onto the first support 16. To this end, the first camera 18 is arranged above the first support 16 with reference to the representation in FIG. 1 by means of a stand 22.

The data processing installation 14 for its part has a first interface 24, an evaluation unit 26 and a database 28, as can be seen in FIG. 2. The first interface 24 connects the data processing installation 14 to the first camera 18 and said data processing installation 14 uses this first interface 24 to receive image data from the first camera 18. This is indicated schematically in FIGS. 1 and 2 by an arrow 30. The image data received in this manner are then forwarded from the first interface 24 to the evaluation unit 26. This is indicated schematically by an arrow 32. The evaluation unit 26 can now directly begin to evaluate and analyse the image data received in this manner, or can store the data in the database 28 first of all. This is indicated by an arrow 34. For the purpose of evaluating the data in the evaluation unit 26, the latter requires reference image data, as described in more detail below. The evaluation unit 26 likewise receives this information from the database 28, as indicated schematically by an arrow 36.

Once the evaluation unit 26 has ascertained an evaluation result, said result is forwarded to a display unit 38. This can be accomplished by means of a separate connection 40 on the data processing installation 14 and is otherwise indicated schematically by arrows 42 and 42′. Various configuration options can be considered for such a display unit 38. Thus, it is firstly conceivable to design specific display units for the intended purpose and to integrate them into the data processing installation 14. Otherwise, it is alternatively conceivable to use an ordinary computer monitor for this purpose, said computer monitor being able to be controlled by means of the connection 40. In addition to these options for visually presenting the evaluation result, it is furthermore conceivable for the latter to be presented audibly. Thus, depending on how detailed the evaluation result communicated to a user should be, an announcement with the necessary information can be made or else simply notification by a signal can take place. The latter can, for example, then be configured differently, either for the positive identification of an instrument or for the placing of an incorrect instrument onto the support.

Besides or in addition to the described option of outputting the evaluation data on the display unit 38, it is also conceivable for the data processing installation 14 furthermore to have a control unit 44. This is shown as an optional element in FIG. 2 by means of dashed lines. The control unit 44 can receive data from the evaluation unit 26, as indicated schematically by an arrow 46, and can then use said data to control external appliances or devices directly or indirectly. This is likewise indicated schematically by an arrow 48. Examples of such devices are robots, which are not shown in more detail here, however.

In order to achieve triggering of the image capture by the first camera 18, the device 10 also contains a push-button 50. This push-button 50 is functionally connected to the first camera 18. This is indicated schematically by means of an arrow 52. In order to otherwise allow further communication between a user and the device 10, the latter also has a keyboard 54 which is connected to the data processing installation 14. This is indicated schematically by means of a connecting line 56.

A medical instrument to be identified is shown schematically in FIG. 1 as a pair of scissors 58. This pair of scissors 58 is arranged on the first support 16. Hence, the pair of scissors 58 is beneath the first camera 18. In line with the perspective orientation of this first camera 18, this pair of scissors 58 is captured by the first camera 18 when the image data are captured.

In order to optimize the snapshots or the image capture, the device 10 also has lighting devices. These lighting devices are shown schematically here by lamps 60 and 61. So as also to avoid reflections from the instruments that are to be identified, elements 62 and 63 for diffuse light conditions are also provided. These elements 62 and 63 may be made from special photo card, for example.

The mode of operation of the fine identification unit 12 will now be explained by way of example with reference to the device 10 and FIGS. 1 and 2. In this context, the method according to the present invention is also described.

Using a given packing list for a corresponding set of instruments, a user places the associated instruments onto the first support 16. These are shown here by means of the pair of scissors 58 and a clamp 64 by way of example. The packing list may either be in separate form for the user on a printout or can be presented using a separate display or else shown to the user by means of the display unit 38.

When all of the instruments in the set of instruments have been placed onto the first support 16, the image data from this set of instruments on the first support 16 are captured by means of the first camera 18. This can be triggered in one preferred embodiment by the user operating the push-button 50. Alternatively, it is also conceivable for the user to use the keyboard 54 for triggering.

The image data captured by the first camera 18 are now forwarded via the first interface 24 to the evaluation unit 26 in the data processing installation 14. There, these image data are then processed in the evaluation unit 26 such that, by using specifically coordinated object identification algorithms, such as correlation methods and methods of edge-based object identification (e.g. generalized Hough transformation), the individual objects, i.e. in this case instruments, are identified using the image data.

When these instruments or objects have been identified, they are then compared with reference images of the relevant instruments. These references are stored in the database 28. Since the instruments to be packed for a set of instruments are known, a comparison can limit itself to comparing the identified objects with the reference images of the instruments which are also part of the set of instruments. In order to be able to perform such a comparison, the relevant reference images from the database 28 are transmitted to the evaluation unit 26.

Once an instrument has been identified, it is then either removed from the available image data or marked as identified and the procedure continues accordingly with the identified objects that still remain. If, after all the identified objects have been compared with the reference images of the instruments to be packed, there are still unassociated objects left in the image data, the data processing installation 14 outputs this as a packing fault by means of the display unit 38. This is also the case when an excessive number of one type of instrument is on the first support 16.

If there are still instruments missing which the packing list for an appropriate set of instruments contains, this is likewise output as a fault in the packing sequence on the display 38.

If, by contrast, the set of instruments provided is complete and is present in the correct number on the first support 16, this is likewise displayed on the display 38 as a complete set of instruments. The user can then continue the procedure with the set of instruments that is arranged on the first support 16, e.g. can sterilize said set of instruments.

In this context, it should be mentioned that, for correct fine identification of the objects on the first support 16, it makes sense to arrange the objects such that they do not overlap one another. However, this does not necessarily have to be the case and can also be provided as an option in specific identification algorithms. This is possible, for example, when restricting the object identification to key features of the instruments.

In order to optimise the capture of the image data, so that the relevant identification algorithms can achieve a high number of hits, it is advisable to ensure good lighting and contrast conditions.

To this end, the first support 16 may be designed to have a contrast-enhancing background 66. This can easily be implemented, by way of example, by virtue of the first support 16 having an even colouring, e.g. blue.

In addition, the lamps 60 and 61 should provide intense lighting of the first support 16 and at the same time ensure the most diffuse light possible, by virtue of the elements 62 and 63, in order to reduce undesirable reflections.

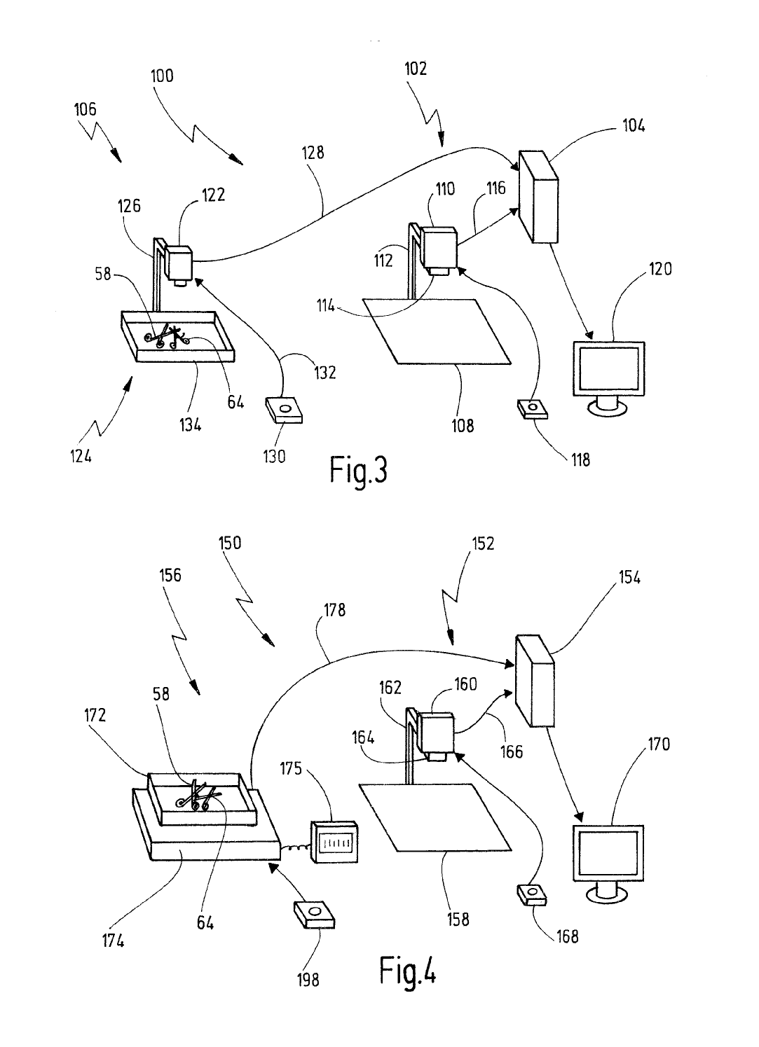

FIG. 3 shows a further device 100 according to the present invention.

This device 100 has a fine identification unit 102, a data processing installation 104 and a coarse identification unit 106.

The data processing installation 104 is designed in the manner of the data processing installation 14 and is not shown in more detail below. Instead, reference is made to the previous comments. The fine identification unit 102 has a first support 108 and a first camera 110. In this case, the first camera 110 is arranged on a stand 112. This allows it to be oriented such that its lens 114 is aiming at the first support 108. The first camera 110 shown in this case therefore has the same perspective as the camera 18 from FIG. 1.

The first camera 110 likewise forwards the captured image data to the data processing installation 104, as indicated by the arrow 116. The capture of the image data can be triggered by a push-button 118 in the same way as in the case of the device 10 from FIG. 1. For the purpose of further communication between the user and the device 100, the data processing installation 104 also has a display unit 120. The remaining features and the mode of operation of the fine identification unit 102 together with the data processing installation 104 are identical, in principle, to the features and mode of operation of the fine identification unit 12 together with the data processing installation 14 of the device 10, for which reason reference is also made in this regard to the explanations made before.

For the purpose of improved illumination and optimization of the contrast ratio between instruments placed on the first support 108, a contrast-enhancing background can likewise be used in this case, in the same way as intense lighting means are used. However, these are not shown in more detail in this case for the purpose of clarity.

The additional coarse identification unit 106 of the device 100 has a further camera 122. This further camera 122 is arranged above a second support 124 in a similar fashion to the first cameras 110 and 18 described before. To this end, it is mounted on a stand 126. The further camera 122 is likewise connected to the data processing installation 104 via a third interface—not shown in more detail in this case. This is indicated schematically by the arrow 128. So as to be able to have image data capture controlled by the user in the case of the coarse identification unit 106 too, the coarse identification unit 106 likewise has a push-button 130. The push-button 130 is functionally connected to the camera 122 for the purpose of triggering. This is indicated schematically by an arrow 132.

The mode of operation of the device 100 is similar to the mode of operation of the device 10. In this case too, a user first of all works through a prescribed packing list and places appropriate instruments onto the first support 108 and, in line with the comments made previously in connection with the fine identification unit 12 and the data processing installation 14, uses the fine identification unit 102 and the data processing installation 104 to check for completeness and correctness. If the instruments are complete, this is likewise output on the display unit 120, whereupon the user then transfers the instruments to the second support 124. The resultant state is indicated schematically in FIG. 3 again by the instruments from FIG. 1, namely the pair of scissors 58 and the clamp 64.

If all the instruments are now arranged on the second support 124, the further camera 122 can start the image capture. This can be triggered by the user, preferably using the push-button 130. The image data ascertained in this manner are then—as illustrated by the arrow 128—forwarded to the data processing installation 104, which can then use its evaluation unit to start the evaluation.

In one preferred embodiment, the second support 124 has an instrument tray 134. The instruments from the set of instruments, that is to say in this case the pair of scissors 58 and clamp 64, can be placed into this instrument tray 134 directly when they are transferred from the fine identification unit 102. This has the advantage that, following successful coarse identification, the instrument tray 134 can be taken out of the coarse identification unit 106 and thus forwarded directly to cleaning and sterilization.

Since the available space in such an instrument tray 134 is usually smaller than the space available on the first support 108 or 16, for example, the instruments to be identified frequently overlap in the coarse identification unit, as is also indicated in FIG. 3 for the pair of scissors 58 and the clamp 64.

So as nevertheless to provide an efficient opportunity to identify the completeness of the instrument set, this situation preferably involves the identification of key features in the image data. By way of example, these key features may have been learnt by the system beforehand or may have been predetermined directly by the user.

A further advantage of the use of key features for identifying the instruments is that the subsequent coarse identification step by the coarse identification unit 106 takes comparatively little time.

The use of the coarse identification unit 106 means that the overall device 100 has the advantage that the instrument tray 134 loaded in this fashion is conclusively checked to determine whether the set of instruments is present in full and the instrument tray 134 has therefore been loaded correctly. This precludes faults such as an instrument not being correctly transferred to the associated instrument tray 134 from a previous identification operation, e.g. with the fine identification unit 102, for example.

Besides the option—described previously and illustrated in the comments below—of a separate coarse identification unit in addition to a fine identification unit, it is likewise conceivable for this invention to involve the units being combined in terms of design. This would mean that the first and second supports and the first and further (or second and further) cameras are identical. Such an arrangement has a smaller space requirement than a separate arrangement.

FIG. 4 shows a further device 150 according to the present invention.

This device 150 according to the invention likewise has a fine identification unit 152, a data processing unit 154 and a coarse identification unit 156.

In a manner comparable to the devices 10 and 100, the fine identification unit 152 has a first support 158 and also a first camera 160 with a stand 162 and a lens 164. The first camera 160 is also connected to the data processing installation 154, as indicated by an arrow 166. The first camera 160 can also be triggered by a push-button 168.

The mode of operation of the fine identification unit 152 is similar to that of the fine identification unit 102, for which reason further explanations are dispensed with here and reference is made only to the previous explanations. A corresponding outcome for the identification of the instruments is then obtained with reference to the set of instruments to be loaded via a display unit 170.

In a manner similarly analogous to the device 100 from FIG. 3, the check on the completeness of an appropriate set of instruments will be followed by coarse identification in the coarse identification unit 156.

To this end, the coarse identification unit 156 also has an instrument tray 172 in the preferred embodiment. This instrument tray 172 is arranged on a scale 174. The scale 174 firstly has a dedicated display unit 175. In addition, the scale 174 is connected to the data processing installation 154 via a second interface 176. This is indicated by an arrow 178 and can also be seen in FIG. 5.

The data processing installation 154 shown schematically in FIG. 5 is essentially identical to the data processing installation 14 in FIG. 2. In this case too, there is a first interface 180 for receiving the image data from the first camera 160. This is indicated schematically by an arrow 166. In addition, the data processing installation 154 also has an evaluation unit 182 and a database 184. The evaluation unit 182 can write data to the database 184 and can read data therefrom, as indicated by arrows 186 and 188. Further, the data processing installation 154 also has an optional control unit 190, which can likewise be supplied with data by the evaluation unit 182 for the purpose of controlling further appliances and devices. This is indicated by an arrow 192. The data processing installation 154 also has a connection 194 which can be used to set up a connection—not shown in more detail—to the display unit 170.

In contrast to the data processing installation 14, the data processing installation 154 additionally has the second interface 176. As already described previously, this is used to forward the data from the scale 174 to the evaluation unit 182. This is indicated schematically by an arrow 196.

If, as indicated in FIG. 4, instruments, in this case the pair of scissors 58 and the clamp 64, are now again placed into the instrument tray 172 as a finished set of instruments, the scale determines the weight of this set of instruments. This is preferably accomplished by operating a push-button 198. The weight of the set of instruments preferably means the total weight thereof. This is preferably accomplished following prior taring of the scale with the instrument tray 172 in order to compensate for unevennesses in the weights of the instrument trays used.

The weight data obtained in this way are then forwarded via the second interface 176 to the evaluation unit 182 of the data processing installation 154. There, they are compared with the nominal weight of the present set of instruments comprising the pair of scissors 58 and the clamp 64. Said nominal weight is stored as a reference in the database 184. If the ascertained weight of the pair of scissors 58 and the clamp 64 matches the stored nominal weight, the data processing installation 154 provides the user with an appropriate notification via the display 170.

If the ascertained weight differs from the stored nominal weight after consideration of any tolerances, however, the user is notified of this as a fault in the set of instruments via the display unit 170.

The user then needs to check the allegedly complete set of instruments once again. Possible faults in this context may be incorrect transfer of the instruments from the fine identification unit to the coarse identification unit and faults particularly in the assembly of more complex instruments. By way of example, single internal parts may be missing. This cannot be identified from the outside and therefore cannot be ascertained by means of the prior fine identification in the fine identification unit 152.

The reference weight or nominal weight of a respective set of instruments may be stored in the database 184 in different ways. One option in this context is for the individual weights of the respective instruments to be stored. These would then each be recalculated by the data processing installation 154 for each appropriate set of instruments and would then be compared with the ascertained weights accordingly. Alternatively, it is also possible to determine nominal weights for complete sets of instruments and hence for said nominal weights to be stored for each set of instruments as a fixed value in the database 184.

The nominal or reference weights of the instruments or sets of instruments are determined either by including manufacturer data in the data processing installation 154 or by means of proprietary weighing in a learning phase. The latter case preferably involves the performance of a plurality of weighing operations with the respective (sets of) instruments, as a result of which, particularly under different ambient conditions such as humidity and temperature, there are a plurality of weights for an instrument or set of instruments. This means that it is then possible to ascertain and store an appropriate fault tolerance using the standard deviation.

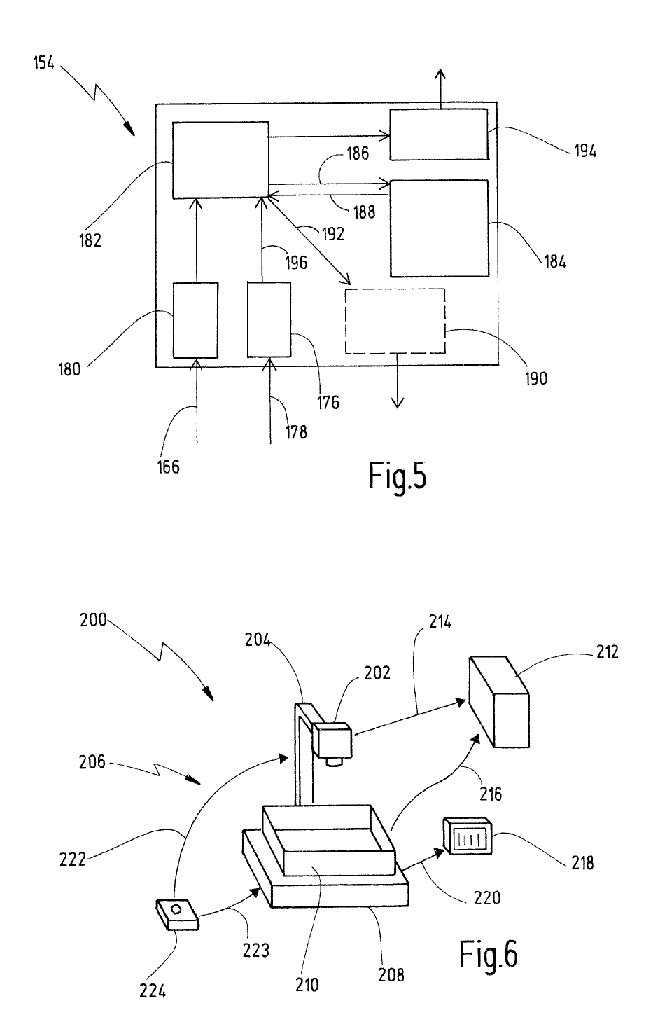

Besides the previously shown refinement of the device 100 and 150 with the coarse identification units 106 and 156, FIG. 6 shows a further preferred embodiment in the form of a coarse identification unit 200.

Even though the coarse identification unit 200 is shown as a single element in this case, it goes without saying that it can be combined in any form with the previously shown fine identification units 12, 102 and 152.

The coarse identification unit 200 can be regarded as a combination of the coarse identification units 106 and 156.

The coarse identification unit 200 has a further camera 202 which is arranged on a stand 204. The arrangement of the further camera 202 is similarly such that it is arranged above a second support 206 and is oriented such that the camera perspective is directed onto this second support 206. The second support 206 also has a scale 208. This scale 208 has an instrument tray 210 arranged on it. Both the further camera 202 and the scale 208 are connected to a data processing installation 212, as indicated schematically by arrows 214 and 216.

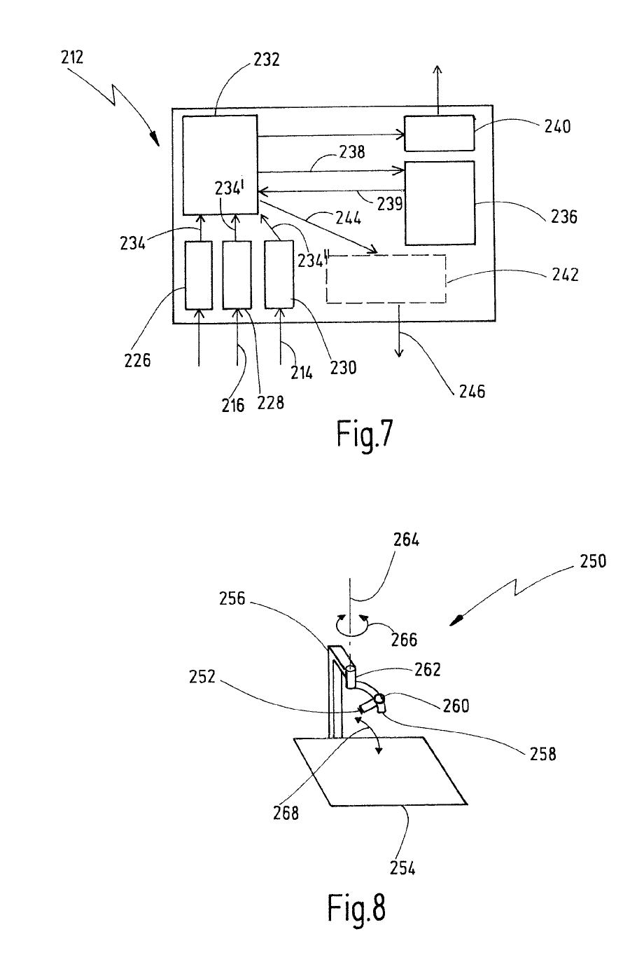

The data processing installation 212 is otherwise of a design similar to the previously described data processing installations 14, 104 and 154 and is described in more detail in conjunction with FIG. 7. It is otherwise connected to a display unit, which is not shown in FIG. 6 for the sake of clarity.

In addition, the scale may also be connected to a dedicated display unit 218, as indicated schematically by an arrow 220. The display unit 218 is then used to display the respective weight of the objects arranged on the scale 208.

In order to trigger the image capture and weighing operations, the further camera 202 and scale 208 are actuated by push-button in this case too, as indicated schematically by arrows 222 and 223. This can be accomplished by separate individual push-buttons or, as shown in FIG. 6 in this case, can be effected by a shared push-button 224.

The coarse identification with the coarse identification unit 200 is essentially similar to the previously described coarse identifications with the coarse identification units 106 and 156. One difference from the previously described coarse identification in this context, however, is the possibility of simultaneous identification using the further camera 202 and the scale 208.

This embodiment has the advantage that it is firstly possible to detect faults in the assembly of more complex instruments on the basis of a weight difference, while the visual individual key features of the respective instruments are nevertheless still able to be checked. This means that it is possible to ensure that each of the provided instruments in the set of instruments has actually been arranged in the instrument tray 210 and is correctly assembled.

In order to be able to receive these data, the data processing installation 212 now has a second interface 228 and a third interface 230 besides a first interface 226. This can be seen in FIG. 7 in particular. All the interfaces 226, 228 and 230 forward their data to an evaluation unit 232, as indicated by arrows 234, 234′ and 234″. The evaluation unit 232 can now interchange the data obtained in this manner with a database 236 and compare them with the reference data from this database 236. This is indicated schematically by arrows 238 and 239. Hence, besides the image data from the respective fine identification units, the evaluation unit 232 can also compare the image data from the coarse identification unit 200 and the weighing data from the coarse identification unit 200 with appropriate reference data.

Further, the data processing installation 212 also has a connection 240 for outputting the data to a display unit—not shown in more detail. The data processing installation 212 may also be provided, again optionally, with a control unit 242 in order to control appropriate devices or units on the basis of the evaluated data. In this case, the transmission of the data from the evaluation unit 232 to the control unit 242 is indicated by an arrow 244. The actuation of external units and devices is indicated by an arrow 246.

FIG. 8 shows a camera arrangement 250. The configuration of this camera arrangement 250 can be transferred to the respective fine identification units 12, 102, 152 or coarse identification units 106 and 200 as appropriate.

The camera arrangement 250 has a camera 252, which is likewise arranged above a support 254. The camera 252 is arranged above the support 254 by means of a stand 256. In this case, the camera arrangement 250 is such that the position of the camera 252 is arranged so as to be alterable and, in this context, the camera 252 can cover a hemispherical surface area of dedicated positions. In this case, the camera 252 is arranged such that it always has its camera perspective oriented in the direction of the support 254.

In the present example, this is achieved by virtue of the stand 256 having a bow 258. Said bow 258 has the camera 252 arranged on it so as to be able to move along said bow 258. By way of example, this movement and arrangement can be effected by a motor 260, which is shown schematically in this case. For its part, the bow 258 has one end arranged on the stand 256 via a second motor 262.

The bow 258 can therefore subsequently make rotations about an axis 264 of the motor 262, as indicated by a double-headed arrow 266. Similarly, the camera 252 can be moved along the bow 258 by the motor 260, as indicated by a double-headed arrow 268.

Ultimately, this configuration of a camera arrangement 250 allows for the respective fine and coarse identification units to provide image data or snapshots from two or an arbitrary number of different perspectives.

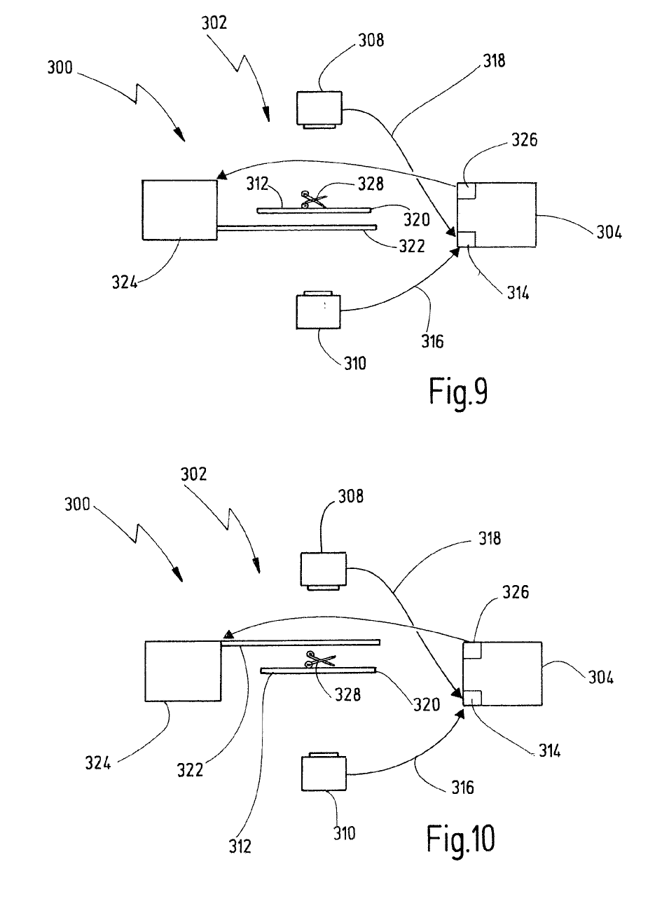

FIGS. 9 and 10 show a further device 300 according to the present invention. The device 300 has a fine identification unit 302, a data processing installation 304 and a coarse identification unit, the latter not being shown in more detail for the sake of clarity. This coarse identification unit is configured in the same way as one of the coarse identification units 106, 156 or 200 already shown and explained before.

Besides a first camera 308, the fine identification unit 302 additionally has a second camera 310. The first camera 308 and the second camera 310 are arranged relative to one another such that they are respectively arranged on one side of a first support 312 of the fine identification unit 302.

Both cameras 308 and 310 are connected to the data processing installation 304 via a first interface 314 which is indicated schematically in this case. This is indicated schematically by arrows 316 and 318.

In the present exemplary embodiment, the first support 312 has a transparent base area 320 and also a contrast-enhancing background 322.

In this case, the transparent base area 320 may be made from any transparent materials. These merely need to allow appropriate snapshots to be taken and instruments to be placed onto said base area 320. Examples which may be mentioned for these materials are glass or transparent plastics, such as Plexiglas.

In this context, the contrast-enhancing background 322 is in the form of a moving unicoloured plate. In addition, the contrast-enhancing background 322 is arranged on a movement unit 324. This movement unit 324 is able to transfer the contrast-enhancing background 322 from a position beneath the transparent base area 320 to a position above the transparent base area 320—in each case in reference to the illustration in FIGS. 9 and 10. This can be effected by means of rotation or by means of a motion sequence of the type lateral displacement, raising and movement back again, for example. It is likewise conceivable to have an arrangement on roller conveyors—which is not shown in this case—which run beside the transparent base area 320 and allow the contrast-enhancing background 322 first of all to be displaced laterally beside the transparent base area 320 and to have its vertical height adjusted so that it can then subsequently be pushed back above or below the transparent base area 320 again.

Further, the movement unit 324 is connected to a control unit 326—likewise indicated only schematically in this case—of the data processing installation 304.

As has already been explained as an option in the previously described exemplary embodiments of the data processing installations, this control unit 326 receives information and signals from an evaluation unit—not shown in more detail here—of the data processing installation 304 and therefore, in this case, controls the displacement and adjustment of the contrast-enhancing background 322 by means of the movement unit 324.

For the purpose of complete automation, it would also be conceivable for the control unit 326 in this case also to control the triggering of the first camera 308 and the second camera 310 and the associated capture of the image data.

With regard to the operation of capturing the image data from a respective instrument, a pair of scissors 328, that is indicated schematically in this case, the first camera 308 first of all captures an image of the pair of scissors 328. In this case, the contrast-enhancing background 322 is arranged beneath the transparent base area 320 such that it has a positive influence on the object identification properties by virtue of it increasing the contrast between the object to be identified, in this case the pair of scissors 328, and the background.

Next, when the image data have been received in the data processing installation 308, the control unit 328 is used to displace the position of the contrast-enhancing background 322 by means of the movement unit 324. This involves said background 322 being brought from beneath the transparent base area 320 into a position above the transparent base area 320. This is comprehensible from the transition from FIG. 9 to FIG. 10.

When the contrast-enhancing background 322 has been positioned, the second camera 310 can now begin to capture the image data. In this context, said second camera 310 can capture the image data from the lower side—with reference to the illustration of FIG. 10—of the pair of scissors 328 through the transparent base area 320. In this case too, the contrast-enhancing background 322 again ensures a sufficient difference between the object to be identified and the background in order to facilitate object identification.

Even though the description of this method has been provided in this order, it is also possible to reverse the order, i.e. to capture first of all the underside and then the top of a pair of scissors 328 in the form of image data.

The image data received in this manner from a first camera 308 and a second camera 310 are then transmitted to the data processing installation 304 and evaluated in the evaluation unit—which is not shown in more detail in this case—of the data processing installation 304 in line with the explanations provided before. As a result, the object, in this case the pair of scissors 328, is identified and is examined with respect to its belonging to the respective packing sequence of the set of instruments to be packed.

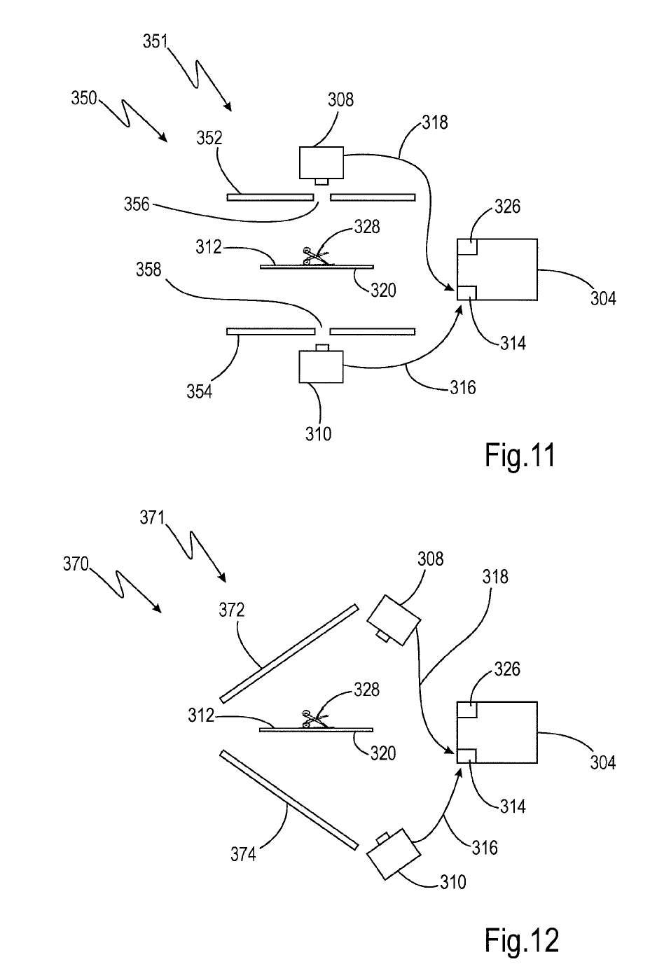

Further devices 350 and 370, as shown in FIGS. 11 and 12, comprise partly identical features as the device 300 of FIGS. 9 and 10. Accordingly, identical features are designated by the same reference numerals and are not described in more detail below. Although not shown in FIGS. 11 and 12 for the sake of clarity, the devices 350 and 370 do, similar to device 300, also optionally comprise a coarse identification unit. This coarse identification unit is configured in the same way as one of the coarse identification units 106, 156 or 200 already shown and explained before.

In contrast to the device 300 of FIGS. 9 and 10, the device 350 of FIG. 11 comprises an fine identification unit 351 with two contrast-enhancing backgrounds 352 and 354. These are respectively arranged each on one side of the first support 312. Therein, these contrast-enhancing backgrounds 352 and 354 are respectively located between the first support 312 and the respective camera 308, 310. In order to allow the capture of image data of the instruments arranged on the first support 312, that is to say on the transparent base area 320, the contrast-enhancing backgrounds 352 and 354 each comprise an opening 356, 358. The cameras 308 and 310 may then capture images of an instrument, e.g. the pair of scissors 328, arranged on the transparent base area 320, through these openings 356 and 358. Therein, the respectively opposite contrast-enhancing background 352 and 354 aids in enhancing the object identification properties, as mentioned before.

With respect to the representation of FIG. 11, the contrast-enhancing background 352 serves as a background for image captures with camera 310, whereas the contrast-enhancing background 354 serves as the background for image captures with camera 308. The possible image capturing of the respectively opposite camera 308 or 310 and of the respective opening 356 or 358 may be considered in the image processing, e.g. by being removed from the image data. This may be done, for example, by using image subtraction, meaning via images taken with and without an instrument. With the device 350 simultaneous and, in the consequence, time saving image captures and therefore object identifications are possible due to the fixed arrangement of cameras 308 and 310 and of contrast-enhancing backgrounds 352 and 354. A time consuming rearrangement and/or reorientation of camera and/or contrast-enhancing background is not necessary.

The device 370 as shown in FIG. 12 comprises an fine identification unit 371 with two contrast-enhancing backgrounds 372 and 374, as well. In contrast to the device 350 of FIG. 11 these contrast-enhancing backgrounds 372 and 374 are inclined with respect to a theoretical plane provided by the first support 312 or the transparent base area 320. This orientation of the contrast-enhancing backgrounds 372 and 374 is such that they may serve as a respective background for the cameras 308 and 310 for also enhancing the object identification properties. For this, the arrangement of cameras 308 and 310 is such that their respective perspective lies also inclined with respect to the aforementioned plane. The configuration shown in this embodiment allows for the image capturing of the pair of scissors 328 with the camera 310 being done in front of the contrast-enhancing background 372, for example. In the same way, the image capturing of the pair of scissors 328 with the camera 308 may be done in front of the contrast-enhancing background 374. Camera 308 and 310 are arranged respectively on the side of the contrast-enhancing backgrounds 372 and 374. Therefore, the contrast-enhancing backgrounds 372 and 374 do not require an additional opening as it is the case for the contrast-enhancing backgrounds 352 and 354 of the device 350. This is due to the inclined arrangement, which avoids the need for capturing the images through the contrast-enhancing backgrounds. In the consequence, also an additional step in processing the image data is not necessary, since the camera 308 or 310 and the respective opening is not a part of the captured image data.

This embodiment has also the advantage that a simultaneous image capture with both cameras 308 and 310 is possible without any delays since a rearrangement and readjustment of the background and/or the camera is not necessary. For this, camera 308 and 310 as well as contrast-enhancing backgrounds 372 and 374 are also preferably fixedly arranged.

It goes without saying that the explanations provided previously with regard to the configuration of a camera, in particular in FIG. 8, can also be transferred to the cameras 308 and 310 shown here in FIGS. 9, 10, 11 and 12. In addition, it also goes without saying that appropriate lighting units are provided in this device and are not shown in more detail merely for the sake of simplification and clarity in the illustrations. Besides the previously illustrated use of lamps, it is further also conceivable for the cameras 308 and 310 shown here, and also for all other cameras and camera devices described before, to contain lighting devices in or on the camera itself. This results in a compact space-saving arrangement.

What is claimed is:

1. A device for assembling sets of medical instruments, with:
a data processing installation,
a fine identification unit, and
a coarse identification unit
said data processing installation having:
a display unit,
a database,
a first interface, and
an evaluation unit; and
said fine identification unit having:
a first support, for placing the medical instruments of a set of instruments thereon, and
a first camera; and
said coarse identification unit having:
a support;
wherein said first camera is arranged and oriented such that it can capture image data of medical instruments to be identified and arranged on said first support from at least one perspective,
wherein said data processing installation is designed such that
it uses said first interface to receive image data from said first camera,
it can store said received image data in said database,
it can use said evaluation unit to compare said received image data with already stored image data from medical instruments, and
it can thereby visually identify a respective medical instrument, and
wherein on said support of said coarse identification unit the instruments can be combined to form a set of instruments following the visual identification in said fine identification unit.

2. The device of claim 1, wherein said support of said coarse identification unit is formed by a second support.

3. The device of claim 1, wherein said support of said coarse identification unit is formed by said first support.

4. The device of claim 1, wherein said first support has a contrast-enhancing background being arranged such that it is located behind an instrument to be identified, from the respective camera perspective.

5. The device of claim 1, wherein said first camera is arranged such that the position thereof can be altered such that it can capture image data from at least two perspectives.

6. The device of claim 1, wherein said first support has a transparent base area onto which the instruments to be identified can be placed.

7. The device of claim 6, wherein said fine identification unit further comprises a second camera being arranged and oriented such that it can capture image data from instruments to be identified and arranged on said first support from at least one further perspective,
wherein said data processing installation is further designed such that
it uses an interface to additionally receive image data from said second camera,
it can store said received image data from said second camera in said database,
it can use said evaluation unit to compare said received image data of said second camera with already stored image data from instruments, and
it can thereby visually identify a respective instrument; and
wherein said first camera is arranged on one side of said transparent base area and said second camera is arranged on the other, opposite side of said transparent base area.

8. The device of claim 7, wherein said second camera is arranged such that the position thereof can be altered such that it can capture image data from at least two perspectives.

9. The device of claim 6, wherein said contrast-enhancing background can be displaced between a plurality of positions, wherein the plurality of positions are each situated on opposite sides of said transparent base area.

10. The device of claim 6, comprising at least two contrast-enhancing backgrounds respectively arranged on opposite sides of said transparent base area such that at least one contrast-enhancing background is arranged behind a medical instrument arranged on said first support with respect to a respective perspective of said at least one camera.

11. The device of claim 1, wherein said support of the coarse identification unit has a scale, and
wherein said data processing installation has a second interface and is further configured such that
it uses said second interface to receive weight data from said scale for the instrument set that has been placed onto said scale,
it can store said received weight data in said database, and
it can use said evaluation unit to compare said received weight data with already stored weight data from the visually identified instruments.

12. The device of claim 1, wherein said coarse identification unit has a camera being arranged and oriented such that it can capture image data from a set of instruments on said support of said coarse identification unit from at least one perspective, and
wherein said data processing installation is further configured such that
it uses an interface to receive image data from said camera of said coarse identification unit,
it can store said received image data in said database,
it can use said evaluation unit to compare said received image data with already stored image data from instruments, and
it can thereby visually identify the respective instruments and can check the completeness of the set of instruments on said support of said coarse identification unit.

13. The device of claim 12, wherein said camera of said coarse identification unit is formed by a further camera, and
wherein said data processing installation has a third interface and is further configured such that it uses said third interface to receive said image data from said further camera.

14. The device of claim 12, wherein said camera of said coarse identification unit is arranged such that the position of said camera of said coarse identification unit can be altered such that it can capture image data from at least two perspectives.

15. The device of claim 1, wherein said support of said coarse identification unit has an instrument tray into which the instruments can be placed and in which the instruments can subsequently be sterilized as a complete set of instruments.

16. A Method for assembling sets of medical instruments using a device for assembling sets of medical instruments, with:
a data processing installation,
a fine identification unit, and
a coarse identification unit
said data processing installation having:
a display unit,
a database,
a first interface, and
an evaluation unit; and
said fine identification unit having:
a first support, for placing the medical instruments of a set of instruments thereon, and
a first camera; and
said coarse identification unit having:
a support;
wherein said first camera is arranged and oriented such that it can capture image data of medical instruments to be identified and arranged on said first support from at least one perspective,
wherein said data processing installation is designed such that
it uses said first interface to receive image data from said first camera,
it can store said received image data in said database,
it can use said evaluation unit to compare said received image data with already stored image data from medical instruments, and
it can thereby visually identify a respective medical instrument, and
wherein on said support of said coarse identification unit the instruments can be combined to form a set of instruments following the visual identification in said fine identification unit;
the method comprising the following steps:
a) placing at least one instrument onto said first support of said fine identification unit,
b) capturing image data by at least said first camera,
c) forwarding said image data to said data processing installation,
d) comparing said image data with the reference images stored in said database for the instruments in the set of instruments that is to be assembled, and
e) informing the user about missing or superfluous instruments or about the completeness of the set of instruments by means of said display unit.

17. The method of claim 16, wherein in step b) the image data are captured by said first camera and a second camera.

18. The method of claim 16, wherein at least one camera captures image data from at least two perspectives by altering the respective position of said at least one camera.

19. The method of claim 16, further comprising the following steps:
f) ascertaining the weight of the set of instruments with said scale,
g) forwarding said weight data from said scale to said data processing installation,
h) comparing said weight data with a nominal weight of the set of instruments, and
i) informing the user about the fault or the completeness of the set of instruments.

20. The method of claim 16, further comprising the following steps:
f) capturing image data of the set of instruments using said camera of said coarse identification unit,
g) forwarding said image data to said data processing installation,
h) comparing said image data with image data stored in said database for the instruments which are part of the set of instruments, and
i) informing the user about the fault or the completeness of the set of instruments,

21. The method of claim 20, wherein said comparison in step h) is made using key features of the instruments.

22. The method of claim 20, further comprising the following steps between steps h) and I):
i) ascertaining the weight of the set of instruments using said scale,
j) forwarding said weight to said data processing installation, and
k) comparing said weight data with a nominal weight for the set of instruments.
